(19) United States
(12) Patent Application Publication
(10) Pub. No.: US 2026/0186475 A1
(43) Pub. Date: Jul. 2, 2026

(54) MANAGEMENT DEVICE AND DISPLAY DEVICE

(71) Applicant: SINTOKOGIO, LTD., Nagoya-Shi (JP)

(72) Inventors: Hayata Kondo, Nagoya-Shi (JP); Yoshitsugu Tanaka, Nagoya-Shi (JP); Tomo Nishigaki, Nagoya-Shi (JP)

(73) Assignee: SINTOKOGIO, LTD., Nagoya-Shi (JP)

(21) Appl. No.: 19/430,171

(22) Filed: Dec. 22, 2025

(30) Foreign Application Priority Data
Dec. 27, 2024 (JP) 2024-231860

(51) Int. Cl. G05B 19/418; G01N 21/88; G01N 21/89

(52) U.S. Cl. CPC G05B 19/41875; G01N 21/8851; G01N 21/8914; G05B 2219/32149; G05B 2219/32368; G05B 2219/45226; G05B 2219/45244

(57) ABSTRACT

A management device manages a manufacturing line for a product. The management device includes a storage for storing sensor information obtained by a sensor disposed in the manufacturing line, a storage for storing control information in the manufacturing line, and a storage for storing defect information including image data of a product determined to be defective with regard to a defect of the product. The management device includes a display unit and a display controller for causing the display unit to display one screen including defect information, sensor information corresponding to the defect information, and control information corresponding to the defect information.

### TECHNICAL FIELD

The present disclosure relates to a management device and a display device.

### BACKGROUND ART

Patent Literature 1 discloses a casting facility including a plurality of processes as a manufacturing line. In this casting facility, a ladle receives molten metal in a melting furnace, and the molten metal is conveyed to a molten metal pouring machine. Further, a plurality of casting molds are molded by a molding machine and conveyed to the molten metal pouring machine one by one. In the molten metal pouring machine, the molten metal in the ladle is poured into the conveyed casting molds. After the molten metal has been poured into the casting mold, the casting mold is cooled over time, and the molten metal is solidified to become a casting before reaching a mold disassembling device. The mold disassembling device disassembles the casting mold and takes out the casting. The casting is shipped as a product through a post process.

### CITATION LIST

### Patent Literature

Patent Literature 1: JP 2023-032851 A

### SUMMARY OF INVENTION

### Technical Problem

A casting that is determined to be defective in an inspection before shipment is manufactured in some cases. Because of this, it is desired to easily check factors causing defects.

An object of the present disclosure is to provide a management device and a display device that make it possible to easily check the factors causing the defects.

### Solution to Problem

A management device of the present disclosure is a management device that manages management objects in a manufacturing line and includes: a first storage that stores sensor information obtained by a plurality of sensors disposed in the manufacturing line; a second storage that stores control information in the manufacturing line; a third storage that stores, with regard to defects of the management objects, defect information including image data of a management object determined to be defective; a display unit; and a display controller that causes the display unit to display one screen including the defect information, the sensor information corresponding to the defect information, and the control information corresponding to the defect information.

A display device of the present disclosure is a display device that displays one screen that includes defect information including image data of a management object determined to be defective, sensor information obtained by a plurality of sensors disposed in the manufacturing line, and control information in the manufacturing line.

### Advantageous Effects of Invention

According to the management device and the display device of the present disclosure, the factors causing defects can be easily checked.

### BRIEF DESCRIPTION OF DRAWINGS

FIG. 1 is a schematic configuration diagram of a manufacturing system of a first embodiment.

FIG. 2 is a block diagram illustrating an example of a configuration of a casting device depicted in FIG. 1.

FIG. 3 is an explanatory diagram illustrating an example of a screen displayed by a management device depicted in FIG. 1.

FIG. 4 is an explanatory diagram illustrating an example of a screen displayed by the management device depicted in FIG. 1.

FIG. 5 is an explanatory diagram illustrating an example of a screen displayed by the management device depicted in FIG. 1.

FIG. 6 is an explanatory diagram illustrating an example of a screen displayed by the management device depicted in FIG. 1.

FIG. 7 is an explanatory diagram illustrating an example of a screen displayed by the management device depicted in FIG. 1.

FIG. 8 is an explanatory diagram illustrating a modification example of a screen displayed by the management device depicted in FIG. 1.

FIG. 9 is an explanatory diagram illustrating a factor table of the management device depicted in FIG. 1.

FIG. 10 is an explanatory diagram illustrating a modification example of a screen displayed by the management device depicted in FIG. 1.

FIG. 11 is an explanatory diagram illustrating a modification example of a screen displayed by the management device depicted in FIG. 1.

FIG. 12 is a schematic configuration diagram of a manufacturing system of a second embodiment.

FIG. 13 is a block diagram illustrating an example of a configuration of a shot processing device depicted in FIG. 12.

FIG. 14 is an explanatory diagram illustrating an example of a screen displayed by a management device depicted in FIG. 12.

FIG. 15 is an explanatory diagram illustrating an example of a screen displayed by the management device depicted in FIG. 12.

FIG. 16 is an explanatory diagram illustrating an example of a screen displayed by the management device depicted in FIG. 12.

FIG. 17 is an explanatory diagram illustrating a modification example of creation of the factor table depicted in FIG. 9.

### DESCRIPTION OF EMBODIMENTS

Hereinafter, embodiments and modification examples will be described with reference to the drawings.

The terms “first”, “second”, “third”, and the like in the present disclosure are used merely to distinguish objects, and are not intended to rank the objects.

### First Embodiment

Hereinafter, a manufacturing system 10 of a first embodiment will be described. Schematic Configuration of Manufacturing System

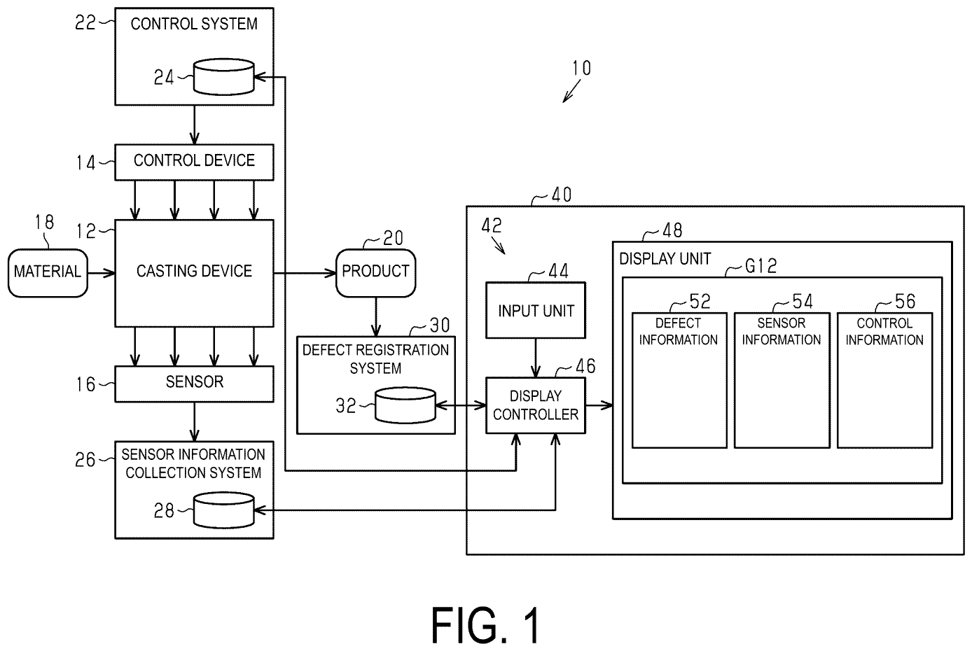

As illustrated in FIG. 1, the manufacturing system 10 includes a casting device 12, a control device 14, and a sensor 16. The casting device 12 constitutes a manufacturing line 12 for manufacturing a product 20 from a material 18. The casting device 12 includes one or more installations for the manufacture of the product 20.

The control device 14 controls the installations included in the casting device 12. The control device 14 controls the installations of the casting device 12 based on control information stored in a storage 24 of a control system 22. Control results in the installations of the casting device 12 controlled by the control device 14 are stored in the storage 24 of the control system 22 via the control device 14. The control information includes information on the installations to be controlled, control parameters for the installations, and the control results in the installations.

The control results include a detection result obtained by a sensor such as a pressure sensor corresponding to an object to be controlled. The control results include a control result of the installation by the control device 14 and a control time for the installation. The control information may include other information. The control device 14 stores the control information in the storage 24, in which the control result and the control time are associated with each other. The storage 24 of the control system 22 is an example of a “second storage”.

The sensor 16 acquires sensor information of various types of management items related to the manufacture in the casting device 12. The sensor 16 is provided in various types of installations included in the casting device 12, and acquires various types of information in the manufacturing line 12. For example, the sensor 16 may include a temperature sensor, a pressure sensor, or an acceleration sensor. A sensor information collection system 26 includes a storage 28. The sensor information collection system 26 stores sensor information acquired by the sensor 16 in the storage 28.

The sensor information includes measurement results of the management items by the sensor 16 and measurement times measured by the sensor 16. The sensor information may include other information. The sensor information collection system 26 stores, as the sensor information, the management items and detection times by the sensor 16 in association with each other in the storage 28. The storage 28 of the sensor information collection system 26 is an example of a “first storage”.

A defect registration system 30 is a system for registering, as defect information, information relating to a product 20 determined to be defective in the shipping inspection. The defect registration system 30 includes a storage 32. The storage 32 stores defect information of the product 20 determined to be defective. Whether the product 20 is a non-defective product or a defective product is determined by, for example, a worker who carries out the inspection. The defect information includes, as information related to the product 20, image data of the product 20 determined to be defective, position data indicating a defective portion in the product 20, and a registration time at which the image data and the position data are registered. The defect information may include other information. The defect registration system 30 stores the image data, the position data, and the registration time in the storage 32 in association with each other. The storage 32 of the defect registration system 30 is an example of a “third storage”.

The manufacturing system 10 includes a management device 40. The management device 40 manages the manufacturing line 12 of the product 20 in the manufacturing system 10.

The management device 40 may be configured as a programmable logic controller (PLC) or a computer system. The computer system includes a central processing unit (CPU), a main storage device such as a random access memory (RAM) and a read only memory (ROM), an input device such as a touch panel or a keyboard, an output device such as a display, and an auxiliary storage device such as a hard disk.

The management device 40 displays various types of screens based on the information stored in the storages 24, 28, and 32 of the respective systems 22, 26, and 30. It can be said that the management device 40 operates based on the information of each of the systems 22, 26, and 30. Then, the management device 40 may function as equipment including the systems 22, 26, and 30. Therefore, it can also be said that the management device 40 includes the storages 24, 28, and 32.

The management device 40 includes a display device 42. The display device 42 displays information related to the manufacturing system 10. The display device 42 includes an input unit 44, a display controller 46, and a display unit 48. The input unit 44 may be an input device of the computer system constituting the management device 40. The display unit 48 may be an output device of the computer system constituting the management device 40.

The display controller 46 controls information collection, a display method, and the like of the display image of the display unit 48. The display controller 46 causes the display unit 48 to display several screens. The screens displayed by the display unit 48 include a screen related to the defect information.

The display controller 46 causes the display unit 48 to display one screen including the defect information, the sensor information corresponding to the defect information, and the control information corresponding to the defect information. In this way, by displaying the sensor information and the control information together with the defect information in one screen, it is possible to easily check defect factors for the product 20.

### Configuration Example of Casting Device

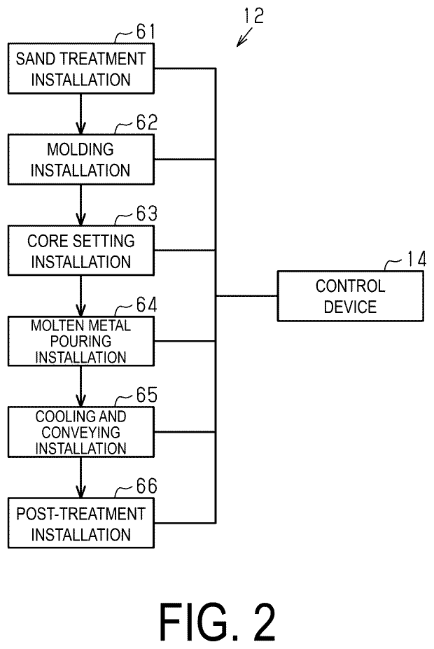

As illustrated in FIG. 2, the casting device 12 includes a sand treatment installation 61, a molding installation 62, a core setting installation 63, a molten metal pouring installation 64, a cooling and conveying installation 65, and a post-treatment installation 66. These installations 61 to 66 illustrate an example of the configuration of the casting device 12, but the configuration of the casting device 12 is not limited thereto.

The installations 61 to 66 of the casting device 12 carry out processes in the manufacturing line 12. The processes carried out by the casting device 12 include a molding process, a core setting process, a cooling and conveying process, a molten metal pouring process, a post-treatment process, and a sand treatment process. The casting device 12 is an example of the manufacturing line 12 including a plurality of the processes.

The sand treatment installation 61 processes molding sand used for molding a casting mold. Specifically, the sand treatment installation 61 separates and removes mixed substances in recovered sand. The sand treatment installation 61 measures a temperature, a moisture content, and the like of the recovered sand, and adds an amount of water proportional to the measured value to the recovered sand. The sand treatment installation 61 further adds an additive such as bentonite and water to the recovered sand and stirs the sand, thereby kneading the recovered sand to produce molding sand (kneaded sand). In the sand treatment installation 61, for example, a CB value (a compactability value), moisture, sand temperature, air permeability, and compression strength are measured by the sensor 16 as parameters (sensor information) that define the status of the sand treatment process. The sensor information may include measurement results by other sensors.

The molding installation 62 charges the molding sand processed by the sand treatment installation 61 into a molding flask, and solidifies the molding sand to mold a casting mold. The casting mold includes an upper casting mold and a lower casting mold. The structure is constituted of upper and lower squeeze boards, a match plate, and an upper or lower flask at the side. The molding installation 62 introduces the molding sand into the molding flask and squeezes the molding sand with the squeeze boards to mold the upper casting mold and the lower casting mold.

In the molding installation 62, an aeration internal pressure and a sand tank internal pressure, a squeeze pressure (upper flask, lower flask), a compression ratio (casting mold compression ratio), and a spray amount of a mold release agent are managed as parameters (control information) that define the status of the molding process. Aeration is an operation in which the molding sand in a sand tank is charged into the molding flask while blowing air from a side wall of the sand tank. In the molding installation 62, the molding time at which the casting mold is molded is managed as control information. The control information may include other information such as a molding cycle.

The core setting installation 63 installs an auxiliary mold called a core in the casting mold in order to manufacture a casting having a hollow portion. In the core setting installation 63, the time of core setting and a setting load, which is a load when the installation is carried out, are managed as parameters (control information) that define the status of the core setting process.

The molten metal pouring installation 64 melts the material 18 such as iron to produce a molten metal, and pours the molten metal into the casting mold. In the molten metal pouring installation 64, the molten metal pouring temperature, the pouring time, and the pouring weight are managed as parameters (control information) that define the status of the molten metal pouring process. The control information may include the pouring time, a material number, and a ladle number of the ladle that conveys the molten metal.

The cooling and conveying installation 65 conveys the casting mold molded in the molding installation 62 to the molten metal pouring installation 64. The cooling and conveying installation 65 also conveys the casting mold into which the molten metal has been poured in the molten metal pouring installation 64 while cooling the casting mold, disassembles the casting mold to take out the casting, and conveys the taken-out casting to the post-treatment installation 66 while further cooling the casting. The disassembled casting mold is sent to the sand treatment installation 61 as recovered sand.

In the cooling and conveying installation 65, the cooling time and the casting mold disassembling time for the conveyed casting mold are managed as parameters (control information) that define the status of the cooling and conveying process.

The post-treatment installation 66 performs post-treatment such as marking on the casting and gate folding of the casting. In the post-treatment process, the product 20 (casting) having been subjected to the post-treatment is inspected by a worker or the like. In the inspection, the presence or absence of a scratch or the like in the product 20 (casting) is checked. In the inspection, when a defect such as a scratch is found in the product 20, the worker determines the product 20 to be defective.

The worker registers the defect information related to the product 20 determined to be defective in the defect registration system 30 illustrated in FIG. 1.

The information registered in the defect registration system 30 includes image data of the product 20 determined to be defective, information on a type of the defect, information on a position of the defect, and a registration time. The information on the type of the defect includes, for example, at least one of the types of defects such as sand inclusion, mold collapse, deviation (mold shift), chipping, mold recess, misrun, dent, crack, shrinkage, blow (air pocket), cold shut, slag, scab, breakage, and sand burning. The information on the position of the defect is information indicating the position of the defect in the product 20 (casting). For example, as for the position of the defect, a position (coordinate values) indicated by the worker with respect to the image data of the product 20 is considered as the information on the position of the defect.

### Display of Information by Management Device

As illustrated in FIG. 1, the display controller 46 of the management device 40 causes the display unit 48 to display various types of screens based on the information stored in the storages 24, 28, and 32 of the systems 22, 26, and 30, respectively. One screen G12 displayed by the display unit 48 includes defect information 52, sensor information 54, and control information 56. The display controller 46 of the management device 40 causes the display unit 48 to display one screen including the defect information 52, the sensor information 54 corresponding to the defect information 52, and the control information 56 corresponding to the defect information 52.

The defect information 52, the sensor information 54, and the control information 56 include a management number set for each management object as information for specifying the management object in the casting device 12.

The management object in the casting device 12 refers to an object processed or utilized in each of the installations 61 to 66 (each process). The management object in the sand treatment process refers to the recovered sand and the molding sand. The management object in the core setting process refers to the casting mold in which a core is to be set. The management object in the molten metal pouring process refers to the molten metal and the casting mold. The management object in the cooling and conveying process refers to the casting mold and the casting. The management object in the post-treatment process refers to the casting (product). The management objects described above are examples. The respective processes are the plurality of processes constituting the manufacturing line 12. The management object is the object to be processed or utilized in each process.

As the management number in the sand treatment process, a mold number of the casting mold into which the molding sand is charged is used. The mold number is an example of an identification number for identifying each individual casting mold. As the management number in the core setting process, a mold number of the casting mold in which the core is set is used, for example. The mold number is associated with information for identifying the set core. As the management number in the molten metal pouring process, a mold number of the casting mold is used, for example. The mold number is associated with a ladle number corresponding to a ladle used for pouring the molten metal into the casting mold. As the management number in the cooling and conveying process, a mold number of the casting mold to be conveyed is used, for example. As the management number in the post-treatment process, a product number (serial number) of the casting is used, for example. The product number is an example of an identification number for individually identifying the casting as a product.

During a period from the sand treatment process to the cooling and conveying process, the control device 14 controls the casting molds to be managed in the installations 61 to 66. The states of the molding sand to be charged into the casting mold to be managed and the like are detected by the sensor 16. Therefore, the sensor information and the control information include the management number for each management object in the casting device 12 as the manufacturing line. The management number is, for example, a mold number corresponding to the casting mold for manufacturing the casting. The sensor information includes a mold number, a detection time by the sensor when the molding sand charged in the casting mold having the above mold number was prepared, and a detection result of the sensor 16. That is, the sensor information includes the mold number as the management number for each management object, and the detection time and the detection result associated with the mold number. Similarly, the control information includes a mold number, a control time of control performed on the casting mold having the above mold number, and control results. The control results include, for example, a sand tank internal pressure when the casting mold is filled with the sand, a temperature able to be detected by the sensor as the molten metal pouring temperature, and a time measured as the pouring time. That is, the control information includes the mold number as the management number for each management object, and the control time and the control result associated with the mold number.

An example of registration of defect information in the defect registration system 30 will be described below.

The worker registers defect information with regard to the casting determined to be defective in the defect registration system 30. The worker operates, for example, an input unit of the defect registration system 30 to cause a display unit of the defect registration system 30 to display a screen for input. Then, the worker takes a picture of the casting determined to be defective with a camera of the defect registration system 30. The worker operates the input unit to input, as data related to the product, the model number of the casting, the product number of the casting, a type of the defect, a position of the defect, and the like. The defect registration system 30 stores the defect information including the various types of input data in the storage 32 based on input confirmation by the worker. The stored defect information includes the registration time of the various types of data including the image data.

The display controller 46 of the management device 40 causes the display unit 48 to display one screen including the defect information of the defect registration system 30, and the sensor information and the control information corresponding to the defect information.

The defect information includes the registration time at which image data or the like of the product determined to be defective is registered. The sensor information includes the management number of the management object and the detection time of each management object. The control information includes the control time of control performed on the management object. The display controller 46 causes the display unit 48 to display the sensor information and control information including the management number corresponding to the product determined to be defective, based on the registration time.

As the management number corresponding to the product determined to be defective, for example, the management number of the sensor information including the detection time within a predetermined period is used based on the registration time of the defect information. As the management number corresponding to the product determined to be defective, for example, the management number of the control information including the control time within a predetermined period is used based on the registration time of the defect information. This is because there is a case where the management number of the sensor information or the control information does not directly correspond to the product determined to be defective.

As described above, in the range from the molding installation 62 to the cooling and conveying installation 65, the casting mold manufactured by the molding installation 62 is conveyed to the installations 61 to 66 in sequence. Therefore, the sensor information and the control information can be referred to by the mold number of the casting mold. However, there is a case where the casting taken out from the casting mold by disassembly is not accompanied by the mold number, the order of the castings after disassembly is different from the conveyed order of the casting molds, or the like. Since the worker cannot perform inspection unless the casting formed by pouring molten metal is sufficiently cooled after being disassembled from the casting mold, the timing of the inspection of the casting may be considerably shifted from the timing of the manufacture of the casting.

Thus, with respect to the registration time of the product (casting) determined to be defective, the display controller 46 of the management device 40 takes a time period including the casting mold by which the registered casting has been manufactured as a predetermined period, and takes the management number of the casting mold that is the management object within the predetermined period as the management number corresponding to the product determined to be defective. This makes it possible to estimate, from the product after disassembly, the management number of the casting mold by which the product has been manufactured. Thus, the display controller 46 displays the sensor information and management information including the management number in one screen together with the defect information of the product. This makes it possible to easily track a factor of the defect.

Depending on the product (casting) to be manufactured, detection may be performed on a plurality of the casting molds within the predetermined period, and a plurality of the detection times, that is, a plurality of the management numbers may be included within the predetermined period. In such a case, the display controller 46 of the management device 40 sets a management number corresponding to the product determined to be defective, based on detection results of a plurality of pieces of the sensor information including the plurality of management numbers. The sensor information includes detection results by the sensor 16. In a casting mold in which there is a variation in the detection result, a defective portion may occur in the product manufactured by the casting mold. In a casting mold with a detection result exceeding a threshold value, a defect may occur in a product manufactured by the casting mold.

Therefore, when the detection times for the plurality of management numbers are within the predetermined period, the display controller 46 takes the detection result having the variation or having the detection result exceeding the threshold value as a specific detection result among the detection results obtained by the sensor 16 within the predetermined period. The display controller 46 takes the management number of the specific detection result among the plurality of management numbers as a management number corresponding to the product determined to be defective. Then, the sensor information and control information including the above management number are displayed in one screen together with the defect information of the product. The information displayed on the screen makes it possible to easily track a factor of the defect.

The detection results may vary relative to the desired detection results for the respective casting molds. The range of variation in the detection result is set, for example, for each detection object such as the moisture content of the molding sand. The detection result with a variation is intended to mean a detection result exceeding a set range of variation. In addition, an allowable range is set for the detection result. The allowable range includes at least one of an upper limit value or a lower limit value for each detection object such as the moisture content of the molding sand. When the detection result falls within the allowable range, the state of the management item of the detection result is determined to be “normal”, and when the detection result does not fall within the allowable range, the state of the management item of the detection result is determined to be “abnormal”. Even when the detection result falls within the allowable range, the state of the management item may be set to “caution” in a case where a difference between the detection result and the upper or lower limit value is smaller than a predetermined value. The threshold value for the detection result may be the upper limit value or lower limit value of the allowable range, or may be a value different from the upper limit value and lower limit value.

The display controller 46 may take the detection result as a specific detection result when the state for the detection result is “abnormal”, and may take the management number of the sensor information including the specific detection result as a management number corresponding to the product determined to be defective. Further, the display controller 46 may take the detection result as a specific detection result when the state for the detection result is “abnormal” or “caution”, and may take the management number of the sensor information including the specific detection result as a management number corresponding to the product determined to be defective.

Although the above description has been given for the sensor information, the same applies to the control information. That is, the control information includes a control result of control performed on the casting mold. In a case of a casting mold with a variation in the control result or a casting mold with the control result exceeding a threshold value, a defective portion may occur in a product manufactured by the casting mold. Therefore, when the control times for the plurality of management numbers are within the predetermined period, the display controller 46 takes the control result with the variation or the control result exceeding the threshold value as a specific control result among the control results within the predetermined period. The display controller 46 takes the management number of the specific control result among the plurality of management numbers as a management number corresponding to the product determined to be defective. Then, the sensor information and control information including the above management number are displayed in one screen together with the defect information of the product. The information displayed on the screen makes it possible to easily track a factor of the defect.

The control results may vary relative to the desired control results for the respective casting molds. The range of variation in the control result is set, for example, for each detection object such as the molten metal pouring temperature. The control result with a variation is intended to mean a control result exceeding a set range of variation. In addition, an allowable range is set for the control result. The allowable range includes at least one of an upper or lower limit value for each detection object such as the molten metal pouring temperature. When the control result falls within the allowable range, the state of the management item of the control result is determined to be normal, and when the control result does not fall within the allowable range, the state of the management item of the control result is determined to be abnormal. The threshold value for the control result may be the upper limit value or lower limit value of the allowable range, or may be a value different from the upper limit value and lower limit value.

The display controller 46 may take the control result as a specific control result when the state for the control result is “abnormal”, and may take the management number of the sensor information including the specific control result as a management number corresponding to the product determined to be defective. The display controller 46 may take the control result as a specific control result when the state for the control result is “abnormal” or “caution”, and may take the management number of the sensor information including the specific control result as a management number corresponding to the product determined to be defective.

### Example of Display Screen

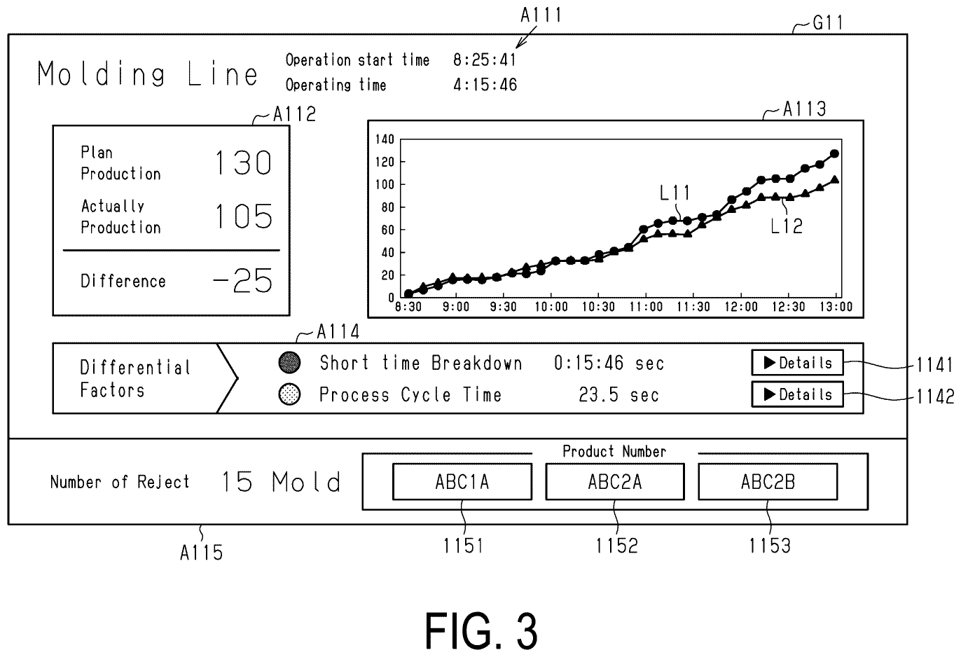

Next, an example of a display screen by the display controller 46 of the management device 40 will be described with reference to FIGS. 3 to 7. Although FIGS. 3 to 7 illustrate a case in which English is used as the display language, the display language may be changed to any language. The display language may be changeable as a setting.

As illustrated in FIG. 3, the display controller 46 of the management device 40 causes the display unit 48 to display a startup screen G11.

The startup screen G11 includes an operation display area A111, an actual production quantity display area A112, a progress display area A113, a difference display area A114, and a defective display area A115.

In the operation display area A111, an operation start time and an operating time are displayed. In the actual production quantity display area A112, a planned quantity (Plan Production), an actual production quantity (Actually Production), and a quantity difference (Difference) are displayed. The progress display area A113 represents a temporal progress (accumulation) of the production quantity, where a graph L11 of the planned quantity and a graph L12 of the actual production quantity with respect to the time of day are displayed. In the difference display area A114, a short time breakdown (Short time Breakdown) and a cycle time (Process Cycle Time) are displayed. In the difference display area A114, details buttons 1141 and 1142 for the short time breakdown and the cycle time, respectively, are displayed. The details buttons 1141 and 1142 each function as a GUI element operated for transitioning from the startup screen G11 to a screen displaying details. The number of defective products and the product numbers 1151, 1152, and 1153 of the castings determined to be defective are displayed in the defective display area A115. The product numbers 1151 to 1153 each function as a GUI element operated for transitioning to a screen displaying defective product information of the corresponding casting.

In the startup screen G11, the planned production quantity and the actual production quantity can be confirmed. In addition, in the startup screen G11, it is possible to confirm the presence or absence of the products determined to be defective by the inspection and the product numbers 1151 to 1153 thereof.

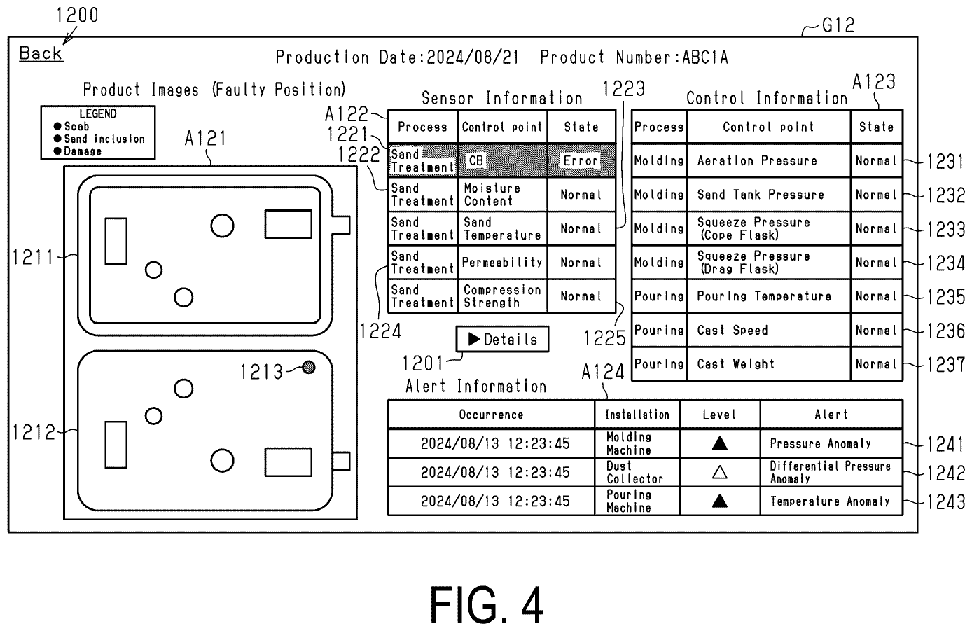

FIG. 4 illustrates a defect information display screen G12 for displaying defective product information of the product number “ABC1A”. When the product number 1151 in FIG. 3 is selected, the display controller 46 in FIG. 1 causes the display unit 48 to display the defect information display screen G12 in FIG. 4. A back button (Back) 1200 is displayed at the upper left of the defect information display screen G12 illustrated in FIG. 4. The back button 1200 functions as a GUI element for transitioning from the defect information display screen G12 to the startup screen G11 illustrated in FIG. 3. The display position of the back button 1200 may be changed to any position.

The defect information display screen G12 includes a first display area A121 of the defect information 52, a second display area A122 of the sensor information 54, and a third display area A123 of the control information 56.

In the first display area A121, pieces of image data 1211 and 1212 of the product included in the defect information 52 and a position indication mark 1213 indicating the defect position are displayed. At least one position indication mark 1213 may be indicated. The display form of the position indication mark 1213 may be changed for each defect type. The display form may be a color, a shape, or the like.

The sensor information 54 corresponding to the product displayed in the first display area A121 is displayed in the second display area A122.

The second display area A122 includes a plurality of display rows 1221 to 1225. The sensor information is displayed in each of the display rows 1221 to 1225. In an example, in each of the display rows 1221 to 1225, a process (Process) in which the sensor information 54 is acquired, a management item (Control Point), and a state (State) are displayed as items of the sensor information 54. The number of display rows in the second display area A122 may be changed as desired. The items displayed in each of the display rows 1221 to 1225 may be changed as desired.

The control information 56 corresponding to the product displayed in the first display area A121 is displayed in the third display area A123.

The third display area A123 includes a plurality of display rows 1231 to 1237. The control information is displayed in each of the display rows 1231 to 1237. In an example, in each of the display rows 1231 to 1237, a process (Process) in which the control information 56 is acquired, a management item (Control Point), and a state (State) are displayed as items of the control information 56. The number of display rows in the third display area A123 may be changed as desired. The items displayed in each of the display rows 1231 to 1237 may be changed as desired.

In FIG. 4, of the sensor information 54 displayed in the second display area A122, the sensor information (display item) “CB (compactability)” and the state “abnormality” (Error) are displayed in the display row 1221. In this manner, the display controller 46 first displays the sensor information determined to be abnormal for the plurality of display rows 1221 to 1225. The sensor information includes detection results by a plurality of the sensors corresponding to the product number as the management number. Therefore, since the sensor information determined to be abnormal is displayed first, the sensor information indicating abnormality can be easily confirmed for the product determined to be defective. In FIG. 4, the control information displayed in the third display area A123 does not include the control information determined to be “abnormal”. As for the control information as well, in a case where the control information determined to be “abnormal” is included, the display controller 46 displays this control information first. Thus, the control information indicating abnormality can be easily confirmed for the product determined to be defective.

The display controller 46 changes the display form of the sensor information displayed in each of the display rows 1221 to 1225 of the second display area A122 in accordance with the state. For example, in the display row 1222, the sensor information (display item) “moisture content” (Moisture Content) is “normal” (Normal). The display controller 46 performs display on the display row 1222 of “Moisture Content” in a first display form. The display controller 46 performs display on the display row 1221 of “CB” in a second display form different from the first display form. The display form is changed by one of or a combination of the color of characters, the background color, blinking of the characters or the background, the thickness of the characters, the form of the characters, and the like. For example, the display row 1221 is indicated with a red background color and the display row 1222 is indicated with a normal color (the background color of the system). In FIG. 4, the difference in background color in the display rows 1221 to 1225 is indicated by dot-hatching, and dots around the characters are omitted to make the characters displayed in the display row 1221 easy to see. When the state is “caution”, the display form may be the same as that of the state “normal” or “abnormal”, or may be a display form different from those of the states “normal” and “abnormal”. The display form is the same in the third display area A123 for displaying the control information.

In FIG. 4, a details button 1201 is displayed below the second display area A122. The details button 1201 functions as a GUI element operated for transitioning to a display screen where details of the sensor information are displayed.

The defect information display screen G12 includes a fourth display area A124 for displaying alarm information (Alert Information). In display rows 1241 to 1243 of the fourth display area A124, information of alarms generated in the casting device 12 illustrated in FIG. 1 is displayed. The information of the alarms includes an occurrence time (Occurrence), an installation (Installation), a level (Level), and an alarm (Alert). The level of the alarm may be expressed by a difference in display form (for example, color). In this way, by displaying the alarm information together with the sensor information and the control information related to the defect of the product, it is possible to easily track a factor of the defect.

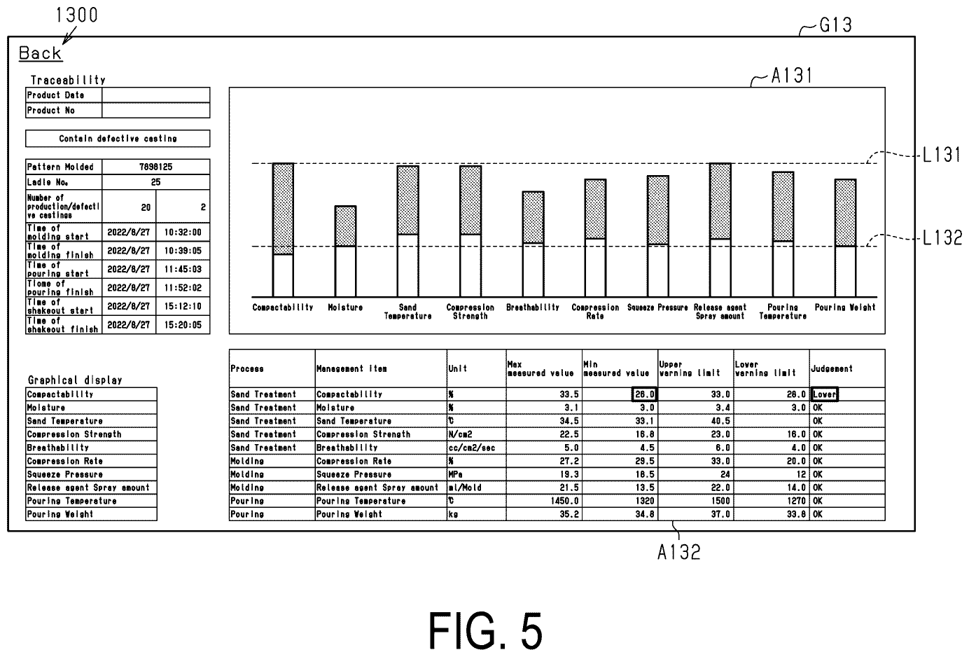

FIG. 5 illustrates a detail display screen G13 for displaying details of the sensor information.

The detail display screen G13 transitions from the defect information display screen G12 when the details button 1201 of the defect information display screen G12 depicted in FIG. 4 is selected. A back button (Back) 1300 is displayed at the upper left of the detail display screen G13 illustrated in FIG. 5. The back button 1300 functions as a GUI element for transitioning from the detail display screen G13 to the defect information display screen G12 illustrated in FIG. 4. The display position of the back button 1300 may be changed to any position.

The detail display screen G13 in FIG. 5 displays more types of sensor information than the second display area A122 in FIG. 4. The detail display screen G13 includes a parameter display area A131 and a management item display area A132. The management item display area A132 displays a list of management items. The details of the sensor information are displayed in the management item display area A132. The sensor information includes a management item, a unit, a maximum value and a minimum value of a detection result, an upper limit value and a lower limit value of an allowable range, and a determination result. In the management item display area A132, the display form of the detection result exceeding the allowable range may be changed. The sensor information likely to be a factor of the defect can be checked in more detail by the sensor information displayed in the management item display area A132.

In the parameter display area A131, the detection results of the respective management items in the management item display area A132 are displayed as bar graphs. A broken line L131 indicating the upper limit of the allowable range and a broken line L132 indicating the lower limit of the allowable range are displayed in the parameter display area A131. The detection results of the respective management items are each displayed with the length of the bar graph adjusted with respect to the broken lines L131 and L132 indicating the allowable range. This makes it possible to easily grasp whether each management item falls within the allowable range.

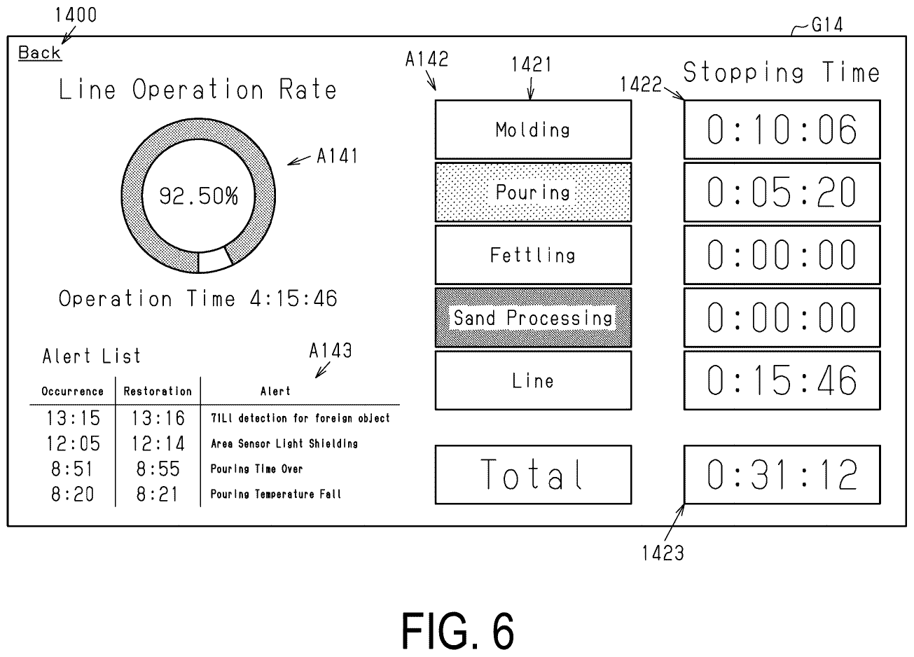

FIG. 6 illustrates a short time breakdown analysis screen G14. The short time breakdown analysis screen G14 appears when the details button 1141 of the startup screen G11 illustrated in FIG. 3 is selected. A back button (Back) 1400 is displayed at the upper left of the short time breakdown analysis screen G14. The back button 1400 functions as a GUI element for transitioning from the short time breakdown analysis screen G14 to the startup screen G11 illustrated in FIG. 3. The display position of the back button 1400 may be changed to any position.

The short time breakdown analysis screen G14 includes a first display area A141 indicating an operation rate, a second display area A142 indicating a stopping time in each process, and a third display area A143 displaying a warning list.

The operation rate displayed in the first display area A141 is a ratio of the actual operation time to the production designated time, and is depicted by a pie chart.

In the second display area A142, there are depicted a process name 1421 in the casting device 12 illustrated in FIG. 1, a stopping time 1422 in each process name 1421, and a total stopping time 1423 in the casting device 12. When the total stopping time 1423 exceeds a set value (threshold value), the display form of the total stopping time 1423 is changed from that in the case where the total stopping time does not exceed the set value. The display form of the stopping times 1422 and 1423 may be one of or a combination of the color of characters, the background color, blinking of the characters or the background, the thickness of the characters, the form of the characters, and the like. In an example, when the set value is exceeded, the stopping times 1422 and 1423 are displayed with red characters.

The display form of the process name 1421 may be changed in accordance with the warning list displayed in the third display area A143. In the third display area A143, the occurrence time of the warning, the registration time, and the type of the warning are displayed as the warning list. The display form of the process name 1421 may be one of or a combination of the color of characters, the background color, blinking of the characters or the background, the thickness of the characters, the form of the characters, and the like. For example, the background color of the process name 1421 is changed to “green”, “yellow”, and “red” in accordance with the warning list. This makes it possible to easily grasp the state of the alarm in each process and the short time breakdown in each process. Accordingly, information necessary for the operation of the installations included in the casting device 12 illustrated in FIG. 1 can be obtained.

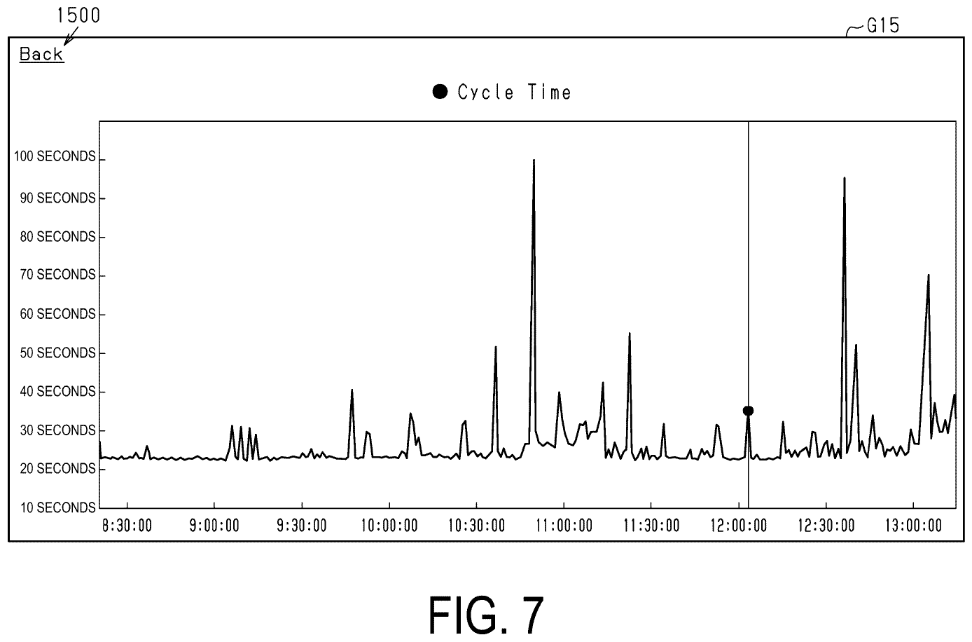

FIG. 7 illustrates a cycle time display screen G15. The cycle time display screen G15 appears when the details button 1142 of the startup screen G11 illustrated in FIG. 3 is selected. A back button (Back) 1500 is displayed at the upper left of the cycle time display screen G15. The back button 1500 functions as a GUI element for transitioning from the cycle time display screen G15 to the startup screen G11 illustrated in FIG. 3. The display position of the back button 1500 may be changed to any position.

The cycle time display screen G15 indicates a cycle time with the horizontal axis representing the time of day and the vertical axis representing time. The cycle time display screen G15 displays the transition of the cycle time in time sequence. The time of day on the horizontal axis can be seen corresponding to the control time in the control information. Accordingly, the cycle time display screen G15 makes it possible to obtain necessary information for the operation of the installations included in the casting device 12 illustrated in FIG. 1.

### Operational Effects of First Embodiment

Hereinafter, operational effects of the first embodiment will be described.
(1-1) The management device 40 manages the manufacturing line 12 (the casting device 12) for the product 20. The management device 40 includes the storage 28 for storing the sensor information obtained by the sensor 16 disposed in the manufacturing line 12, the storage 24 for storing the control information in the manufacturing line 12, and the storage 32 for storing the defect information including image data of the product determined to be defective with regard to a defect of the product 20. The management device 40 includes the display unit 48 and the display controller 46 for causing the display unit 48 to display the one screen G12 including the defect information 52, the sensor information 54 corresponding to the defect information 52, and the control information 56 corresponding to the defect information 52.

In this way, by displaying the sensor information and the control information together with the defect information in one screen, it is possible to easily check defect factors for the product 20 determined to be defective.
(1-2) The sensor information includes the management number for each management object in the manufacturing line, the detection time for each management object with respect to the plurality of sensors, and the detection results obtained by the sensors in association with each other. The control information includes the control time and the control state in the manufacturing line in association with the management number. The defect information includes the registration time of image data. The display controller 46 takes at least one of the management number of the sensor information including the detection time corresponding to the registration time or the management number of the control information including the control time corresponding to the registration time as a management number corresponding to the product determined to be defective, and causes the display unit to display the sensor information and the control information including the management number.

As a result, in a case where the management number of the defect information does not directly correspond to the management number of the sensor information or the control information, the sensor information of the management number including the detection time corresponding to the registration time may be the detection result of the sensor 16 for the product 20 determined to be defective. The control information of the management number including the control time corresponding to the registration time may be a result of control performed on the product 20 determined to be defective. Thus, by displaying the sensor information and the control information for the product 20 determined to be defective in the defect information display screen G12, it is possible to easily check defect factors for the product 20 determined to be defective.
(1-3) The display controller 46 takes the management number with the detection time of the sensor information being within a predetermined period with respect to the registration time as the management number corresponding to the product determined to be defective. The sensor information including the detection time within the predetermined period with respect to the registration time includes the detection result of the sensor 16 for the product 20 determined to be defective. Thus, by displaying the sensor information that is more likely to be a defect factor for the product 20 determined to be defective, the defect factor for the product 20 determined to be defective can be easily checked.
(1-4) The display controller 46 takes the management number with the control time of the control information being within a predetermined period with respect to the registration time as the management number corresponding to the product determined to be defective. The control information including the control time within the predetermined period with respect to the registration time includes the control result for the product 20 determined to be defective. Thus, by displaying the control information that is more likely to be a defect factor for the product 20 determined to be defective, the defect factor for the product 20 determined to be defective can be easily checked.
(1-5) When the detection times for the plurality of management numbers are within the predetermined period, the display controller 46 takes a detection result having a variation or a detection result exceeding a threshold value as a specific detection result among the detection results obtained by the sensors within the predetermined period, and takes a management number of the specific detection result among the plurality of management numbers as the management number corresponding to the product determined to be defective.

A defect may occur in the product 20 manufactured by the casting mold from which the detection result having the variation or the detection result exceeding the threshold value is obtained. Thus, when the number of management numbers of the detection time within the predetermined period is more than one, by displaying the sensor information that is more likely to be a defect of the product 20, the defect factor for the product 20 determined to be defective can be easily checked.
(1-6) When the detection times for the plurality of management numbers are within the predetermined period, the display controller 46 takes a control result having a variation or a control result exceeding a threshold value as a specific control result among the control results obtained by the sensors within the predetermined period, and takes a management number of the specific control result among the plurality of management numbers as the management number corresponding to the product determined to be defective.

A defect may occur in the product 20 manufactured by the casting mold from which the control result having the variation or the control result exceeding the threshold value is obtained. Thus, when the number of management numbers of the detection time within the predetermined period is more than one, by displaying the control information that is more likely to be a defect of the product 20, the defect factor for the product 20 determined to be defective can be easily checked.
(1-7) The display controller 46 displays the detection results of the plurality of sensors in a first display form, and causes the specific detection result to be displayed in a second display form different from the first display form.

Since the specific detection result is visually recognized with ease by such a display, it is possible to more easily track the defect factor.
(1-8) The display controller 46 displays the plurality of control results in a first display form, and causes the specific control result to be displayed in a second display form different from the first display form.

Since the specific control result is visually recognized with ease by such a display, it is possible to more easily track the defect factor.
(1-9) The manufacturing line forms a casting mold and pours molten metal into the casting mold to obtain a casting as a product, and the product determined to be defective is a casting taken out from the casting mold. The detection result of the sensor 16 and the control result for the casting mold in the manufacturing process are managed by the mold number of the casting mold, but the mold number does not correspond to the casting taken out from the casting mold in some cases. In this regard, by using the detection time and the control time for the registration time of the defect information of the casting determined to be defective by the inspection, the casting mold can be easily associated with the casting determined to be defective. Accordingly, by displaying the defect information of the casting determined to be defective, and the sensor information and control information corresponding to the defect information in the one screen G12, the defect factor can be more easily tracked.

### Modification Example of First Embodiment

The first embodiment can be modified and implemented as follows. The first embodiment and the following modification example can be implemented in combination with each other within a range where no technical contradiction occurs. In the following modification example, the same reference signs as those in the first embodiment are given to the same components as those in the first embodiment, and the description thereof will be omitted.

The display controller 46 may display the detection results of the sensor information in the second display area A122 in descending order of the amount of variation in the detection result. The larger the amount of variation in the detection result is, the larger the influence on the occurrence of a defect in the product 20 is in some cases. By displaying the sensor information as discussed above, the defect factor for the product 20 determined to be defective can be easily tracked. Likewise, the display controller 46 may display the control results of the control information in the third display area A123 in descending order of the amount of variation in the control result. By displaying the control information as discussed above, the defect factor for the product 20 determined to be defective can be easily tracked.

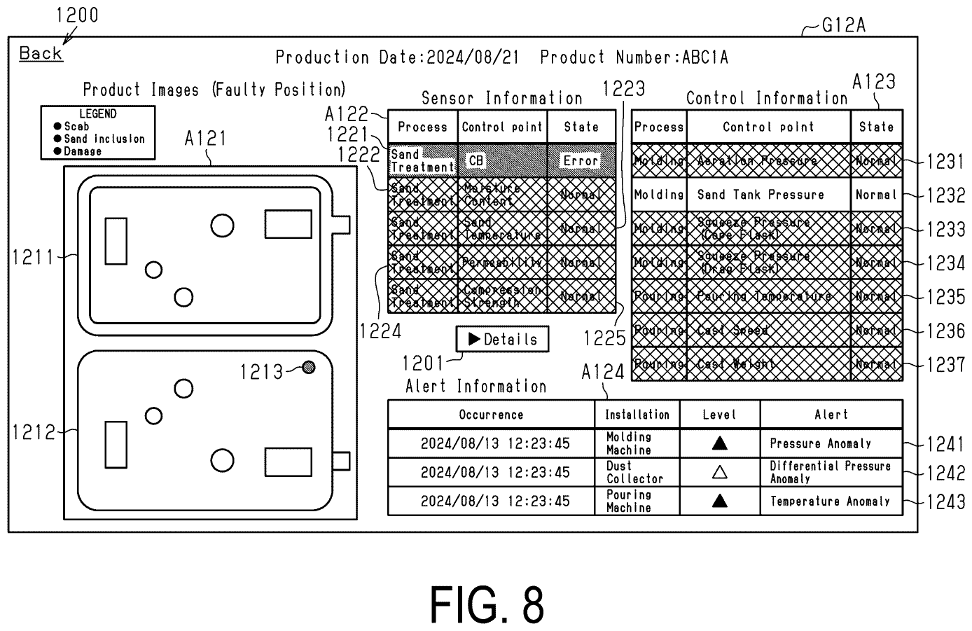

FIG. 8 illustrates a defect information display screen G12A of the modification example to be displayed in the management device 40.

The defect information display screen G12A is displayed by selecting the product number 1151 depicted in FIG. 3, similarly to the defect information display screen G12 illustrated in FIG. 4. When the back button 1200 is selected, the screen transitions to the startup screen G11 illustrated in FIG. 3.

In the defect information display screen G12A, the display form of the second display area A122 is different from that of the defect information display screen G12 illustrated in FIG. 4. In the defect information display screen G12A of the modification example, the sensor information with the state being “normal” among pieces the sensor information displayed in the second display area A122 is displayed in a so-called grayed-out expression in which the entirety of each of the display rows 1222 to 1225 is displayed in gray, for example, so that the characters are unlikely to be visually recognized. With such display form, the sensor information whose state is “abnormal” is more easily recognized. Due to this, the sensor information displayed in the defect information display screen G12A makes it possible to more easily track the defect factors.

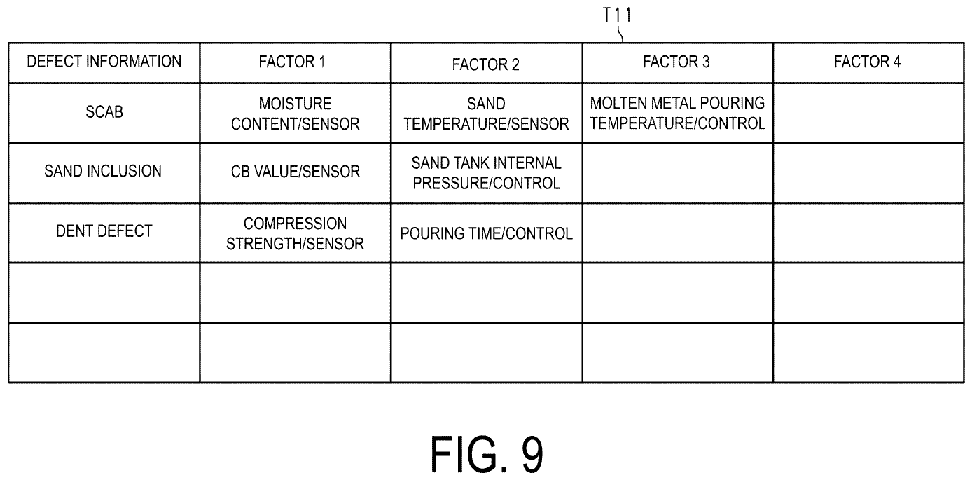

The management device 40 may display the defect information display screen G12A using a factor table T11 (see FIG. 9), in which the defect information and the factors are stored in association with each other. The factor table T11 stores defect classifications (defect types) and defect factors for the defect classifications in association with each other. The defect factors each include at least one item of the detection items related to the sensor 16 or control items related to the control information for the defect classification. The defect factors are each set based on the type of a defect that has occurred in the past and a factor causing the defect. In the example depicted in FIG. 9, with respect to “scab” as defect information, “moisture content” of the sensor 16 is associated as factor 1; “sand temperature” of the sensor 16 is associated as factor 2; and “molten metal pouring temperature” in the control is associated as factor 3. With respect to “sand inclusion” as defect information, “CB value” of the sensor 16 is associated as factor 1; and “sand tank internal pressure” in the control is associated as factor 2. With respect to “dent defect” as defect information, “compression pressure” of the sensor 16 is associated as factor 1; and “pouring time” in the control is associated as factor 2.

The display controller 46 of the management device 40 reads out the factors associated with the defect information registered in the defect registration system 30 illustrated in FIG. 1, based on the factor table T11; then, with respect to only the “CB value” that is the sensor information of the factor, that is, with respect the display row 1221 illustrated in FIG. 8, the display rows 1222 to 1225 are displayed in a so-called grayed-out expression in which the entirety of each of the display rows 1222 to 1225 is displayed in gray, for example, so that the characters are unlikely to be visually recognized. This makes it possible to easily check the state of the sensor information associated as the factor for the defect information, whereby the defect factor can be tracked more easily.

In the defect information display screen G12A illustrated in FIG. 8, in the third display area A123, the display rows 1231 and 1233 to 1237 may be grayed out based on the factor table T11 in FIG. 9, and the display form of the display row 1232 may be allowed not to be changed. By doing so, the display row 1232 can be visually recognized with ease. This makes it possible to easily check the state of the control information associated as the factor for the defect information, whereby the defect factor can be tracked more easily.

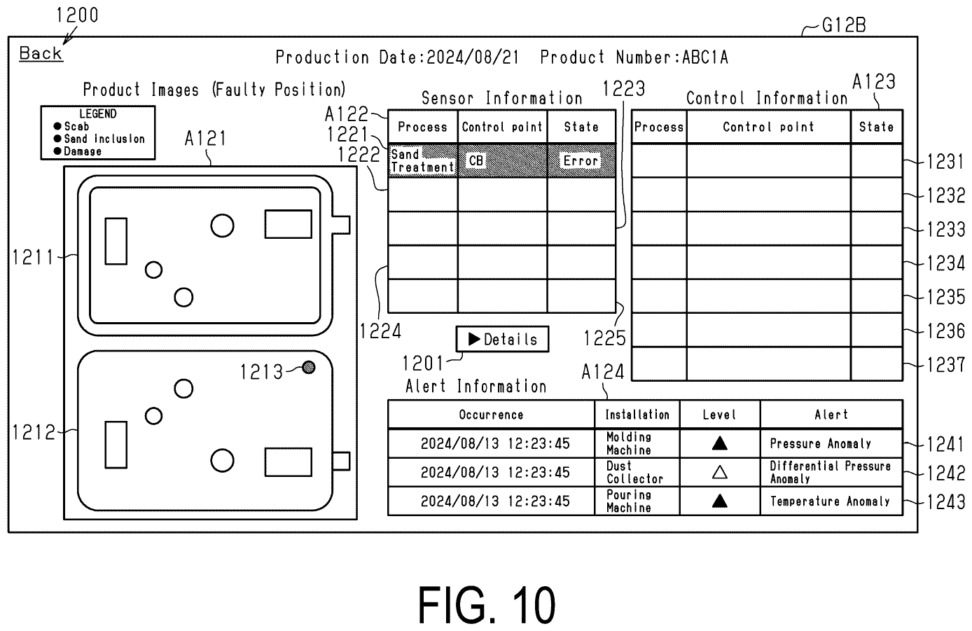

As illustrated in FIG. 10, the management device 40 may display a defect information display screen G12B including only the sensor information and control information related to the defect information of the product. In an example, the management device 40 displays only the sensor information and control information in a state determined to be abnormal for the defect information of the product 20 determined to be defective. For example, in the defect information display screen G12B, the sensor information is displayed only for the display row 1221 of the second display area A122, and the sensor information of the display rows 1222 to 1225 is not displayed. In the modification example illustrated in FIG. 10, since the control information is not determined to be abnormal, the control information is not displayed for the display rows 1231 to 1237. The sensor information or the control information determined to be abnormal often becomes a defect factor of the product 20. Because of this, the defect factor for the product 20 determined to be defective can be easily tracked.

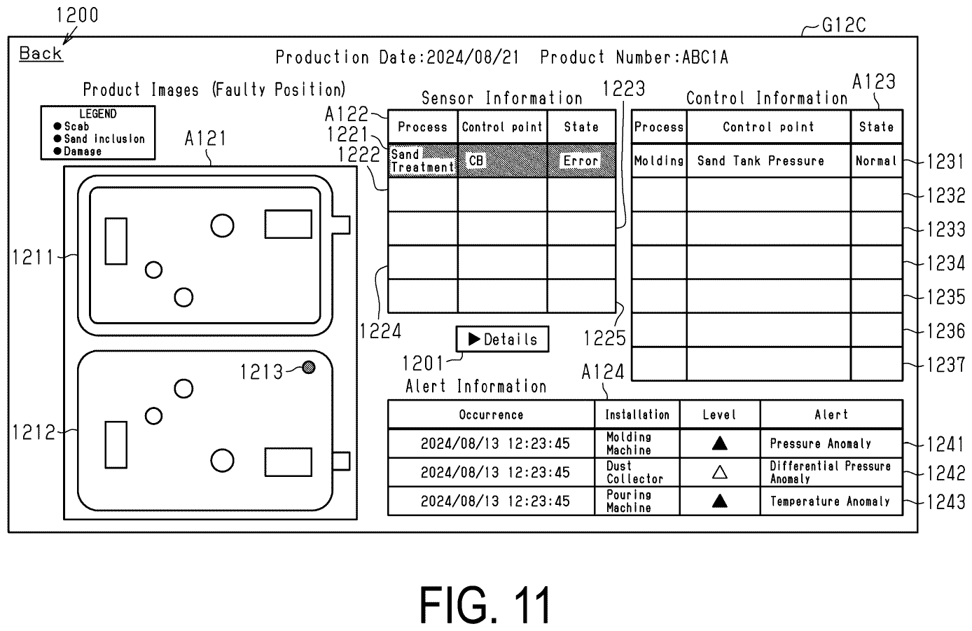

As illustrated in FIG. 11, the management device 40 may display only the information stored as a factor in the factor table T11 depicted in FIG. 9 in a defect information display screen G12C for the defect information of the product 20 determined to be defective. In the example illustrated in FIG. 9, with respect to “sand inclusion” as defect information, “CB value” of the sensor 16 is associated as factor 1; and “sand tank internal pressure” in the control is associated as factor 2. The management device 40 displays only “CB” and “Error” as the sensor information in the display row 1221 of the second display area A122 of the defect information display screen G12C. The management device 40 displays only “sand tank internal pressure (Sand Tank Pressure)” and “Normal” as the control information in the display row 1231 of the third display area A123 of the defect information display screen G12C. Due to this, the sensor information and control information displayed in the defect information display screen G12C make it possible to more easily track the defect factor for the product 20 determined to be defective.

The management object to be registered in the defect registration system 30 is not limited to the product 20, and is any management object in the casting device 12. For example, defect information of a casting mold may be registered as a management object. In the case of a casting mold, there is a case where the casting mold is determined to be defective by the worker during the process of setting a core. In this case, the worker who sets the core or a person who receives a notification from the worker registers the defect information in the defect registration system 30. In this way, by registering the defect information of the management object other than the product 20, it is possible to track a defect factor in the manufacturing system 10.

### Second Embodiment

Hereinafter, a manufacturing system 210 of a second embodiment will be described.

In the manufacturing system 210 of the second embodiment, the same constituent elements as those of the manufacturing system 10 of the first embodiment are denoted by the same reference signs, and part of the description thereof may be omitted.

### Schematic Configuration of Manufacturing System

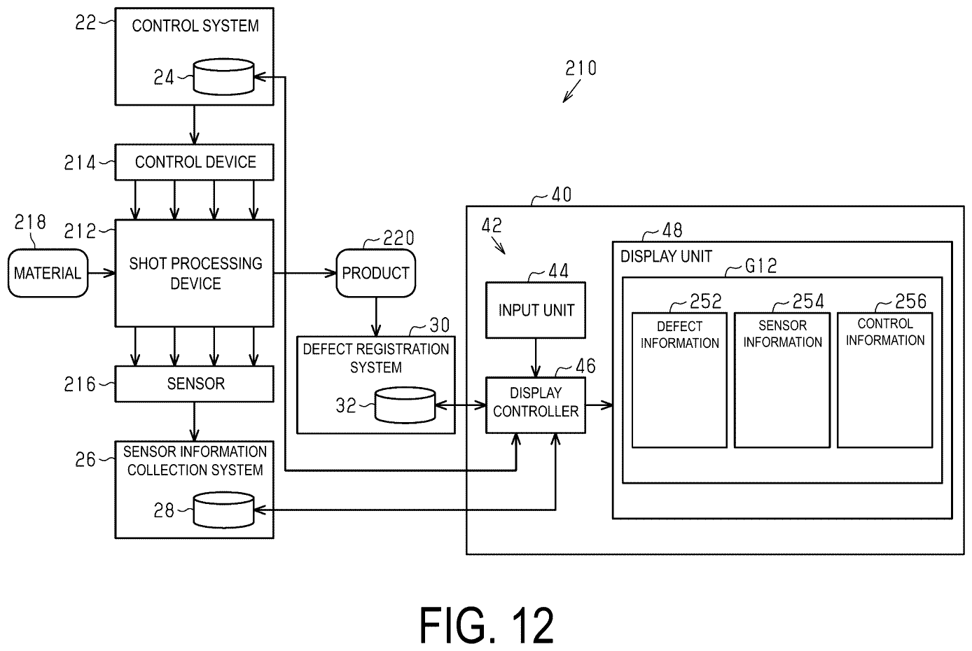

As illustrated in FIG. 12, the manufacturing system 210 includes a shot processing device 212, a control device 214, and a sensor 216. The shot processing device 212 constitutes a manufacturing line 212 for manufacturing a product 220 from a material 218. The shot processing device 212 includes one or more installations for the manufacture of the product 220.

The shot processing device 212 performs surface treatment on a workpiece as a management object. The material 218 supplied to the shot processing device 212 is a workpiece before surface treatment, and is a processing subject for shot processing. The management number of the material 218 is, for example, a product number marked on the material 218. The product 220 manufactured by the shot processing device 212 is a workpiece after surface treatment. The management number of the product 220 is a product number marked on the product 220. That is, the management object in the manufacturing system 210 of the second embodiment includes the workpiece before surface treatment and the workpiece after surface treatment. Examples of the surface treatment include shot blasting for descaling, deburring, surface roughening, and the like of a workpiece such as a steel material, and shot peening processing for improving fatigue strength and the like. The shot processing device 212 processes the surface of the workpiece by projecting or injecting a shot material onto the surface of the workpiece.

The control device 214 controls installations included in the shot processing device 212. The control device 214 controls the installations of the shot processing device 212, based on control information stored in the storage 24 of the control system 22. Control results in the installations of the shot processing device 212 controlled by the control device 214 are stored in the storage 24 of the control system 22 via the control device 214. The control information includes information on the installations to be controlled, control parameters for the installations, and the control results in the installations.

The control result includes a detection result obtained by a sensor such as a current sensor corresponding to an object to be controlled. The control result includes a control result of the installation by the control device 214 and a control time for the installation. The control result may include other information. The control device 214 stores the control information in the storage 24 in association with the control result and the control time. The storage 24 of the control system 22 is an example of the “second storage”.

The sensor 216 acquires sensor information of various types of management items related to the manufacture in the shot processing device 212. The sensor 216 is provided in various types of installations included in the shot processing device 212, and acquires various types of information in the manufacturing line. For example, the sensor 216 may include a temperature sensor. The sensor information collection system 26 includes the storage 28. The sensor information collection system 26 stores sensor information acquired by the sensor 216 in the storage 28. The sensor information includes a measurement result of a management item by the sensor 216 and a measurement time measured by the sensor 216. The sensor information may include other information. The sensor information collection system 26 stores, as the sensor information, the management item by the sensor 216 and the detection time in the storage 28 in association with each other. The storage 28 of the sensor information collection system 26 is an example of the “first storage”.

The defect registration system 30 is a system for registering, as defect information, information relating to the product 220 determined to be defective in the shipping inspection. The defect registration system 30 includes the storage 32. The storage 32 stores defect information of the product 220 determined to be defective. Whether the product 220 is a non-defective product or a defective product is determined by, for example, a worker who carries out the inspection. The defect information includes, as information related to the product 220, image data of the product 220 determined to be defective, position data indicating a defective portion in the product 220, and a registration time at which the image data and the position data are registered. The defect information may include other information. The defect registration system 30 stores the image data, the position data, and the registration time in the storage 32 in association with each other. The storage 32 of the defect registration system 30 is an example of the “third storage”.

The manufacturing system 210 includes the management device 40. The management device 40 manages the manufacturing line of the product 220 in the manufacturing system 210.

The management device 40 displays various types of screens based on the information stored in the storages 24, 28, and 32 of the respective systems 22, 26, and 30. The management device 40 includes the display device 42. The display device 42 displays information related to the manufacturing system 210. The display controller 46 controls information collection, a display method, and the like of the display image of the display unit 48. The display controller 46 causes the display unit 48 to display several screens. The screens displayed by the display unit 48 include a screen related to the defect information.

The display controller 46 causes the display unit 48 to display one screen including the defect information, the sensor information corresponding to the defect information, and the control information corresponding to the defect information. In this way, by displaying the sensor information and the control information together with the defect information in one screen, it is possible to easily check defect factors for the product 220.

### Example of Configuration of Shot Processing Device

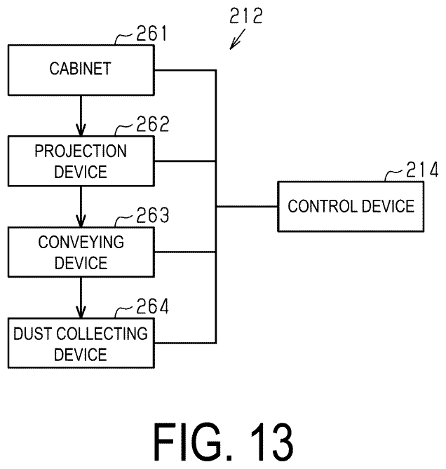

As illustrated in FIG. 13, the shot processing device 212 includes, as installations, a cabinet 261, a projection device 262, a conveying device 263, and a dust collecting device 264. FIG. 13 illustrates an example of the configuration of the shot processing device 212, and the configuration of the shot processing device 212 may be changed as desired.

The cabinet 261 is a housing configured to accommodate the material 218 as a treatment object. A treatment chamber for performing shot processing on the treatment object is provided inside the cabinet 261.

The projection device 262 performs shot processing by projecting a blasting abrasive on the object. The projection method of the projection device 262 is, for example, an impeller type (centrifugal type). An air type may be used as the projection method. As the blasting abrasive, for example, steel shot or steel grit is used. The type of the blasting abrasive may be selected in accordance with the shot processing.

The projection device 262 includes a blasting abrasive tank, a control cage, and an impeller. The blasting abrasive tank stores the blasting abrasive. The control cage is a member for adjusting the area of an opening in a path from the blasting abrasive tank toward the impeller. The control cage supplies a predetermined amount of blasting abrasive to the impeller. The impeller is rotated at high speed by, for example, a motor. The blasting abrasive supplied onto a blade of the impeller is projected by a centrifugal force generated by the rotation. The projection device 262 may include a plurality of the impellers. In an example, the projection device 262 includes five impellers.

The conveying device 263 carries the material 218 as a treatment object into the treatment chamber of the cabinet 261. In addition, the conveying device 263 carries the processed product 220 out of the treatment chamber of the cabinet 261.

The dust collecting device 264 collects dust generated by the shot processing.

In the projection device 262, the ambient temperature is detected by the sensor 216 as sensor information. In the projection device 262, energy generated by the collision of the blasting abrasive used for the shot processing is converted into heat. The heat generated by the projection device 262 may affect the durability of the motor that drives the impeller, the conveying device, and the like in the projection device 262. In the projection device 262, a current value of the motor that drives the impeller (impeller current value), a particle size of the blasting abrasive, a conveying speed, and the like are managed as control information.

As illustrated in FIG. 12, the display controller 46 of the management device 40 causes the display unit 48 to display various types of screens, based on various types of information stored in the storages 24, 28, and 32 of the systems 22, 26, and 30, respectively. One screen displayed by the display unit 48 includes defect information 252, sensor information 254, and control information 256. The display controller 46 of the management device 40 causes the display unit 48 to display one screen including the defect information 252, the sensor information 254 corresponding to the defect information 252, and the control information 256 corresponding to the defect information 252.

### Example of Display Screen

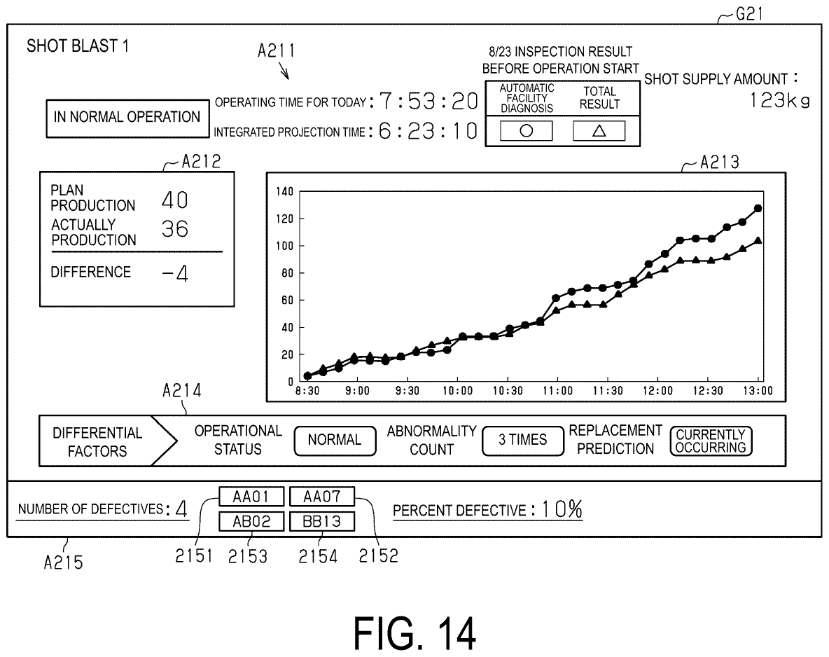

Next, an example of a display screen by the display controller 46 of the management device 40 will be described with reference to FIGS. 14 to 16. Although FIGS. 14 to 16 illustrate a case in which Japanese is used as the display language, the display language may be changed to any language. The display language may be changeable as a setting.

As illustrated in FIG. 14, the display controller 46 of the management device 40 causes the display unit 48 to display a startup screen G21.

The startup screen G21 includes an operation display area A211, an actual production quantity display area A212, a progress display area A213, a difference display area A214, and a defective display area A215.

An operational status, operating time, integrated projection time, inspection result before operation start, and shot supply amount of the shot processing device 212 are displayed in the operation display area A211.

The planned quantity, the actual production quantity, and the difference are displayed in the actual production quantity display area A212.

The progress display area A213 represents a temporal progress (accumulation) of the production quantity, where a graph of the planned quantity and a graph of the actual production quantity with respect to the time of day are displayed.

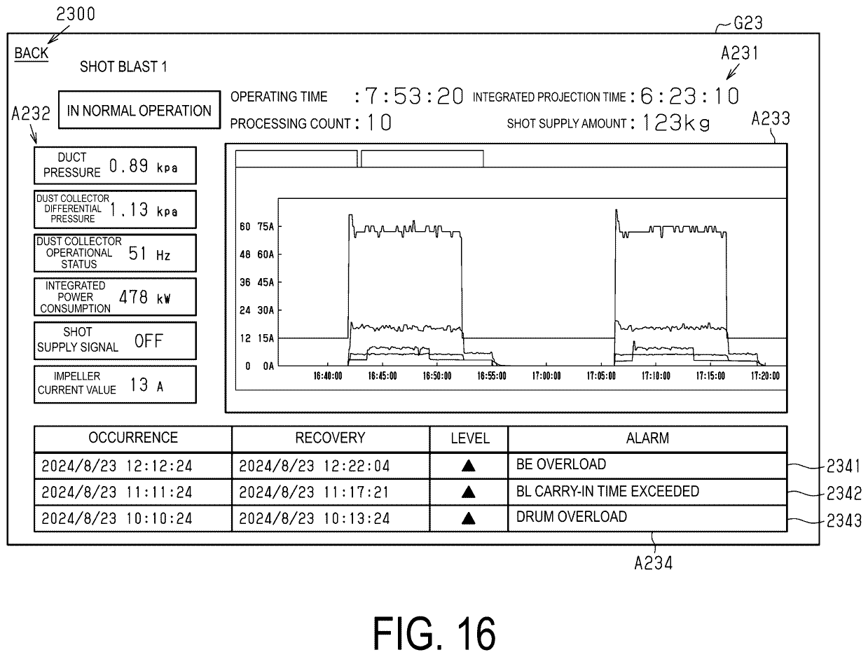

The current operational status, abnormality count, and the replacement prediction are displayed in the difference display area A214. In this case, the replacement prediction is issued when a consumable component in the shot processing device 212 is approaching the period for replacement, and it is issued, for example, when an impeller is approaching the period for replacement. These function as GUI elements operated for transitioning to an operation status display screen G23 in FIG. 16.

In the defective display area A215, product numbers 2151 to 2154 of the products 220 determined to be defective and the percent defective are displayed. The product numbers 2151 to 2154 each function as a GUI element operated for transitioning to a screen displaying defective product information of the corresponding product 220.

In the startup screen G21, the planned production quantity and the actual production quantity can be confirmed. In addition, in the startup screen G21, it is possible to confirm the presence or absence of the products determined to be defective by the inspection and the product numbers 2151 to 2154 thereof.

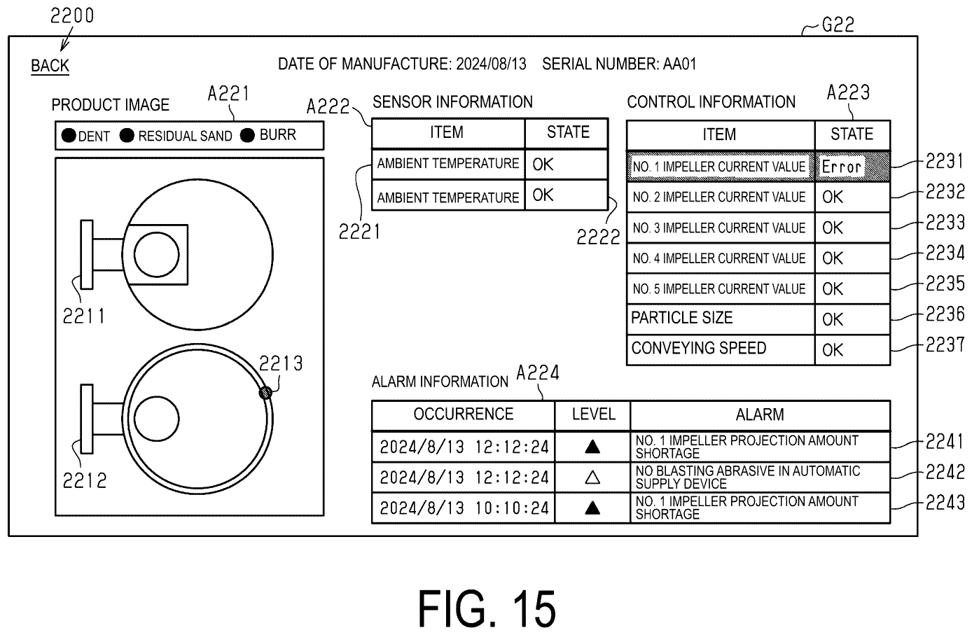

FIG. 15 illustrates a defect information display screen G22 for displaying defective product information of the product number “AA01”. When the product number 2151 in FIG. 14 is selected, the display controller 46 in FIG. 12 causes the display unit 48 to display the defect information display screen G22 in FIG. 15. A back button 2200 is displayed at the upper left of the defect information display screen G22 in FIG. 15. The back button 2200 functions as a GUI element for transitioning from the defect information display screen G22 to the startup screen G21 illustrated in FIG. 14. The display position of the back button 2200 may be changed to any position.

The defect information display screen G22 includes a first display area A221 for the defect information 252, a second display area A222 for the sensor information 254, and a third display area A223 for the control information 256.

In the first display area A221, pieces of image data 2211 and 2212 of the product included in the defect information 252 and a position indication mark 2213 indicating the defect position are displayed. At least one position indication mark 2213 may be indicated. The display form of the position indication mark 2213 may be changed for each defect type. The display form may be a color, a shape, or the like.

The sensor information 254 corresponding to the product displayed in the first display area A221 is displayed in the second display area A222. The sensor information includes states of detection results by the plurality of sensors corresponding to the product number as the management number. Therefore, since the sensor information determined to be abnormal is displayed first, the sensor information indicating abnormality can be easily confirmed for the product determined to be defective.

The control information 256 corresponding to the product displayed in the first display area A221 is displayed in the third display area A223. As for the control information as well, in a case where the control information determined to be “abnormal” is included, the display controller 46 displays this control information first. Thus, the control information indicating abnormality can be easily confirmed for the product determined to be defective.

In the second display area A222, the display form is changed in accordance with the state, similarly to the second display area A122 of the first embodiment illustrated in FIG. 4. In the second display area A222, the sensor information whose status is “normal” may be displayed in a manner that is difficult to visually recognize, for example, by displaying the sensor information in gray characters. Only the sensor information whose status is “abnormal” may be displayed in the second display area A222.

In the third display area A223, the display form is changed in accordance with the state, similarly to the second display area A122 of the first embodiment illustrated in FIG. 4. In the third display area A223, the control information whose status is “normal” may be displayed in a manner that is difficult to visually recognize, for example, by displaying the control information in gray characters. Only the control information whose status is “abnormal” may be displayed in the third display area A223.

The defect information display screen G22 includes a fourth display area A224 for displaying alarm information. In display rows 2241 to 2243 of the fourth display area A224, information of alarms generated in the shot processing device 212 illustrated in FIG. 12 is displayed. The information of the alarms includes an occurrence time, a level, and an alarm. The level of the alarm may be expressed by a difference in display form (for example, color). In this way, by displaying the alarm information together with the sensor information and the control information related to the defect of the product, it is possible to easily track a factor of the defect.

FIG. 16 illustrates an operation status display screen G23. The operation status display screen G23 appears when the difference display area A214 depicted in FIG. 14 is selected. A back button 2300 is displayed at the upper left of the operation status display screen G23. The back button 2300 functions as a GUI element for transitioning from the operation status display screen G23 to the startup screen G21 illustrated in FIG. 14. The display position of the back button 2300 may be changed to any position.

The operation status display screen G23 includes a first display area A231 for displaying the operational status and the like. The operational status, operating time, integrated projection time, processing count, and shot supply amount of the shot processing device 212 are displayed in the first display area A231.

The operation status display screen G23 includes a second display area A232 for displaying the sensor information and the control information, and a third display area A233 for displaying a graph representing a time-series transition of the sensor information and the control information. The sensor information and the control information displayed in the second display area A232 indicate values obtained at the current time point. The current and past operation statuses can be confirmed in the operation status display screen G23.

The operation status display screen G23 includes a fourth display area A234 for displaying alarm information. In display rows 2341 to 2343 of the fourth display area A234, information of alarms generated in the shot processing device 212 illustrated in FIG. 12 is displayed. The information of the alarms includes an occurrence time, a recovery time, a level, and an alarm. The level of the alarm may be expressed by a difference in display form (for example, color). In this way, by displaying the alarm information together with the sensor information and the control information related to the defect of the product, it is possible to easily track a factor of the defect.

### Operational Effects of Second Embodiment

Hereinafter, operational effects of the second embodiment will be described.
(2-1) As for the product 220 processed by the shot processing device 212 constituting the manufacturing line of the manufacturing system 210 of the second embodiment, it is possible to easily track defect factors, similarly to the manufacturing system 10 of the first embodiment.

### MODIFICATION EXAMPLE

The above-described embodiment can be modified and implemented as follows. The above-described embodiment and the following modification example can be implemented in combination with each other within a range where no technical contradiction occurs. In the following modification example, the same reference signs as those in the above-described embodiment are given to the same components as those in the above-described embodiment, and the description thereof will be omitted.

The factors for the defect information in the factor table T11 illustrated in FIG. 9 may be stored by, for example, a worker.

The factor table T11 may be created by machine-learning.

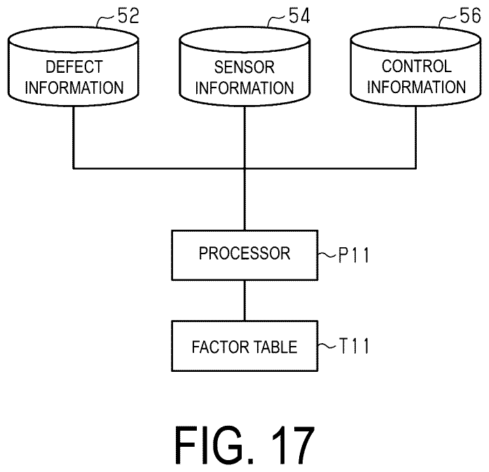

As illustrated in FIG. 17, a processor P11 creates the factor table T11 using a trained model constructed by machine-learning, using the defect information 52, the sensor information 54, and the control information 56. One or multiple processors P11 may be provided. In this way, the factor table T11 is created through machine-learning by the one or multiple processors P11. This makes it possible to easily create the factor table T11. Further, since the machine-learning is used, it is possible to easily add the configuration contents and factors of the factor table T11, and the like.

In the defect registration system 30, the determination for each of the products 20 and 220 may be performed by, for example, a computer that executes image processing. The computer inspects each of the manufactured products 20 and 220 by using a trained model constructed by machine-learning by using image data of non-defective products and image data of defective products in the past. Then, the computer stores the inspection result in the storage 32 as defect information.

The embodiments disclosed herein are merely examples in all respects, and the present invention is not limited to these examples. That is, the scope of the present invention is defined by the claims, and is intended to include any modifications within the meaning and scope equivalent to the claims.

### REFERENCE SIGNS LIST

10 . . . Manufacturing system, 12 . . . Casting device (Manufacturing line), 14 . . . Control device, 16 . . . Sensor, 18 . . . Material, 20 . . . Product, 22 . . . Control system, 24 . . . Storage, 26 . . . Sensor information collection system, 28 . . . Storage, 30 . . . Defect registration system, 32 . . . Storage, 40 . . . Management device, 42 . . . Display device, 44 . . . Input unit, 46 . . . Display controller, 48 . . . Display unit, 52 . . . Defect information, 54 . . . Sensor information, 56 . . . Control information, 61 . . . Sand treatment installation, 62 . . . Molding installation, 63 . . . Core setting installation, 64 . . . Molten metal pouring installation, 65 . . . Cooling and conveying installation, 66 . . . Post-treatment installation, 210 . . . Manufacturing system, 212 . . . Shot processing device (Manufacturing line), 214 . . . Control device, 216 . . . Sensor, 218 . . . Materia, 220 . . . Product, 252 . . . Defect information, 254 . . . Sensor information, 256 . . . Control information, 261 . . . Cabinet, 262 . . . Projection device, 263 . Conveying device, 264 . . . Dust collecting device, 1141, 1142 . . . Details button, 1151 to 1153 . . . Product number, 1200 . . . Back button, 1201 . . . Details button, 1211, 1212 . . . Image data, 1213 . . . Position indication mark, 1221 to 1225 . . . Display row, 1231 to 1237 . . . Display row, 1241 to 1243 . . . Display row, 1300, 1400 . . . Back button, 1421 . . . Process name, 1422, 1423 . . . Stopping time, 1500 . . . Back button, 2151 to 2154 . . . Product number, 2200 . . . Back button, 2211, 2212 . . . Image data, 2213 . . . Position indication mark, 2241 to 2243 . . . Display row, 2300 . . . Back button, 2341 to 2343 . . . Display row, A111 . . . Operation display area, A112 . . . Actual production quantity display area, A113 . . . Progress display area, A114 . . . Difference display area, A115 . . . Defective display area, A121 to A124 . . . First display area to fourth display area, A131 . . . Parameter display area, A132 . . . Management item display area, A141 to A143 . . . First display area to third display area, A211 . . . Operation display area, A212 . . . Actual production quantity display area, A213 . . . Progress display area, A214 . . . Difference display area, A215 . . . Defective display area, A221 to A224 . . . First display area to fourth display area, A231 to A234 . . . First display area to fourth display area, G11 . . . Startup screen, G12, G12A to G12C . . . Defect information display screen (screen), G13 . . . Detail display screen, G14 . . . Short time breakdown analysis screen, G15 . . . Cycle time display screen, G21 . . . Startup screen, G22. Defect information display screen, G23 . . . Operation status display screen, L11, L12 . . . Graph, L131, L132 . . . Broken line, P11 . . . Processor, T11 . . . Factor table

1. A management device configured to manage management objects in a manufacturing line, the management device comprising:
a first storage configured to store sensor information obtained by a plurality of sensors disposed in the manufacturing line;
a second storage configured to store control information in the manufacturing line;
a third storage configured to store, with regard to defects of the management objects, defect information including image data of a management object determined to be defective;
a display unit; and
a display controller configured to cause the display unit to display one screen including the defect information, the sensor information corresponding to the defect information, and the control information corresponding to the defect information.

2. The management device according to claim 1, wherein
the sensor information includes a management number for each of the management objects in the manufacturing line, a detection time for each of the management objects with respect to the plurality of sensors, and detection results obtained by the plurality of sensors in association with each other,
the control information includes a control time and a control state in the manufacturing line in association with the management number,
the defect information includes a registration time of the image data, and
the display controller takes at least one of the management number of the sensor information including the detection time corresponding to the registration time or the management number of the control information including the control time corresponding to the registration time as a management number corresponding to the management object determined to be defective, and causes the display unit to display the sensor information and the control information including the management number

3. The management device according to claim 2, wherein
the display controller takes the management number with the detection time of the sensor information being within a predetermined period with respect to the registration time as the management number corresponding to the management object determined to be defective.

4. The management device according to claim 3, wherein
when a plurality of the detection times for a plurality of the management numbers are within the predetermined period, the display controller takes a detection result having a variation or a detection result exceeding a threshold value as a specific detection result among the detection results obtained by the plurality of sensors within the predetermined period, and takes a management number of the specific detection result among the plurality of management numbers as the management number corresponding to the management object determined to be defective.

5. The management device according to claim 4, wherein
the display controller displays the detection results of the plurality of sensors in a first display form, and causes the specific detection result to be displayed in a second display form different from the first display form.

6. The management device according to claim 3, wherein
the display controller causes the sensor information to be displayed in descending order of an amount of variation in the detection result among the detection results of the plurality of sensors.

7. The management device according to claim 3, wherein
the display controller causes, among the detection results of the plurality of sensors, only sensor information the detection result of which is abnormal to be displayed in the display unit.

8. The management device according to claim 2, wherein
the display controller takes the management number with the control time of the control information being within a predetermined period with respect to the registration time as the management number corresponding to the management object determined to be defective.

9. The management device according to claim 8, wherein
when a plurality of the control times for a plurality of the management numbers are within the predetermined period, the display controller takes a management number for which a control result in control of the manufacturing line is determined to be abnormal among the plurality of management numbers as the management number corresponding to the management object determined to be defective.

10. The management device according to claim 9, wherein
the display controller causes, among a plurality of the control results, only a control item the control result of which is abnormal to be displayed in the display unit.

11. The management device according to claim 3, wherein
the display controller
includes a factor table in which a type of the defect and at least one item of detection items related to the plurality of sensors and control items related to control are associated with each other as a factor of the defect for the type of the defect, and
takes the management number of an item in which the factor of the defect has changed or an item that has exceeded a threshold value within the predetermined period as the management number corresponding to the management object determined to be defective with respect to the factor of the defect associated with the type of the defect of the defect information, based on the factor table.

12. The management device according to claim 11, further comprising
one or more processors configured to create the factor table by machine-learning.

13. The management device according to claim 2, wherein
the manufacturing line forms a casting mold and pours molten metal into the casting mold to obtain castings as the management objects,
the management object determined to be defective is a casting taken out from the casting mold, and
the management number includes an identification number of the casting mold.

14. The management device according to claim 2, wherein
the manufacturing line performs shot processing on processing subjects to obtain the management objects, and
the management number includes an identification number of each of the processing subjects.

15. A display device configured to
display one screen that includes defect information including image data of a management object determined to be defective, sensor information obtained by a plurality of sensors disposed in a manufacturing line, and control information in the manufacturing line.
